(19) United States
(12) Patent Application Publication
(10) Pub. No.: US 2007/0189031 A1
(43) Pub. Date: Aug. 16, 2007

(54) Method for making an abraded optical fiber illumination means

(76) Inventor: Stephen A. Delmar, Gilbert, AZ (US)

Correspondence Address: THE HILL LAW FIRM, PLC, 13592 N 93RD PL, SCOTTSDALE, AZ, 85260, US

(21) Appl. No.: 11/353,667

(22) Filed: Feb. 14, 2006

(51) Int. Cl. G09F 13/18; F21S 4/00; F21V 7/04; G02B 6/04

(52) U.S. Cl. 362/556; 385/115; 385/123; 362/565; 362/551; 362/554

(57) ABSTRACT

An incoherent bundle of optical fibers surrounded by a tubing are selectively damaged to create a decorative lighting effect. With the optical fibers inside the tubing, the tubing is periodically partially cut, abraded, poked or otherwise worked so that damage to the optical fibers can be caused that creates numerous decorative lights that are spaced in relation to each other. In a first preferred embodiment, a distortion aperture is abraded, cut, poked or melted for the purpose of exposing the bundle to a tool that can be applied through the aperture. The tool, which may be the same tool used to create the distortion aperture, is worked against at least one of the optical fibers in the bundle such that at least some cladding is damaged, resulting in a distortion of the light transmission of the bundle. Some or all of the internally reflected light in the waveguide is allowed to escape, depending on the extent of the damage. The distortion aperture may be used to direct light, especially where the tubing material is opaque. The randomness of the damage means that some fibers may lose a considerable amount of their light through a distortion aperture, and other fibers may transmit substantially all of their light to a cut end. This randomness of light intensities allows for a less precise method because the light emanating from adjacent distortion apertures will never be identical, therefore no specific intensity is expected when viewing numerous tiny lights that form a soft lighting effect.

### BACKGROUND OF THE INVENTION

Numerous methods have been developed to decoratively display light using optical fibers. Most commonly, a single fiber displays only a single circular spot of light at a cut end of the fiber. Reed, in U.S. Pat. No. 6,361,198, showed how the tips of fiber optic strands may be cut to result in a more diffused light that will further enhance the effect of a decorative display. Esch, in U.S. Pat. No. 5,757,717, showed how the cut end of an optical fiber may be roughened or abraded to damage the cladding, or otherwise provide a light-diffusing tip on the end of the optical fiber.

To reduce cost and minimize the number of optical fibers required to provide a desired decorative lighting effect, several methods for processing a single optical fiber strand to produce multiple light emitting portions have been developed. Zarian et al., in U.S. Pat. Nos. 5,987,199 and 6,289,150, made uniform cuts or notches in a cladding covered optical fiber core to emit light along a length. The Zarian et al. method can use a conventional mechanical cutter, such as for the various waveguide coupling preparations shown by Yoshimura et al. in U.S. Pat. No. 5,999,670, except that the prepared notch is allowed to split off some of the light into the surrounding environment rather than into another waveguide. Cutting or bending a fiber is somewhat effective, but controlling the amount of light output at an intermediate portion of an optical fiber has proven to be more difficult than controlling or manipulating the light output at an end.

Freier et al., in, U.S. Pat. No. 6,301,418, sandblasted or otherwise roughened the inner surface of the cladding used with a core having about a 7 mm to 18 mm diameter, the core often being a fluid or flowable. The Freier et al. method can only process cladding that is separate from a core material, and because the inner surface of the cladding is being processed, each optical fiber cladding must be processed individually by a vibrating device, orbital sander, rotating brush, jigsaw, or abrasive particle blaster. When Freier et al. used a solid core, the core needed to be vigorously pushed into the cladding and then the cladding needed to be heat shrunk to the core. The Freier et al. method would not work well with a 1 mm diameter or smaller core because hand tools are too big to fit inside the cladding, and the cladding on small diameter optical fiber is much too thin to undergo such an abrasive process, so this method would not be suitable for decorative lighting.

The thinner cores of optical fiber used for decorative lighting makes single fibers that have been cut or bent more susceptible to fracturing, which in turn makes it difficult to assemble or use these fibers. To overcome this weakened core problem, Tang, in U.S. Pat. No. 6,907,168, suggested a rolling process to create middle portion light segments along a length of optical fiber. The rolling process will roughen the outer surface of cladding for an entire 10 to 15 mm circular segment without damaging the core. A similar process was disclosed by Lee in U.S. Pat. No. 5,901,267, but for providing continuous spot-illumination. Once an optical fiber has been rolled or spot cut, numerous individual fibers can be bundled for use as decorative lighting.

### SUMMARY OF THE INVENTION

The preferred embodiment of the present invention provides a decorative illumination means by applying an abrasion process to portions of at least one bundle of optical waveguiding elements that is substantially contained inside of a jacketing, such as flexible tubing. The preferred method is to process numerous distortion apertures through the tubing at least deep enough to break through part of the tubing until there is abrasion damage to at least the cladding of one optical fiber in the bundle, but not so deep as to fracture or cut every core in the bundle. The abrasion process will usually damage between a quarter and a half of the jacketing near an abrasion, and about a quarter to a half of the optical fibers will usually be damaged in the process. Each optical fiber that is affected by the abrasion process will contain areas of damaged cladding or a fractured core that will cause some or most of the conveyed light in the damaged fibers to be emitted through the distortion aperture. This method avoids handling individual fibers, which greatly simplifies the process, but the randomness of the damage to fibers in one of the incoherent optical fiber bundles means that it is unlikely that any two distortion apertures in series will share the same light intensity.

More specifically, the most preferred embodiment uses an incoherent bundle of about ten optical fibers having diameters of about half a millimeter that are strung through a flexible tubing. About every 100 millimeters, a distortion aperture is created by applying an abrasive rotary tool, such as a medium grit sanding wheel, against a cross-section of the flexible tubing. The distortion aperture will be jagged and somewhat oblong in shape. The un-abraded side of the same cross-section of tubing will be relatively untouched, so the integrity of the entire length of tubing isn't compromised very much even though the interior has been breeched. In the process, several optical fibers nearest the distortion aperture will be nicked, cut, abraded, or melted. The relatively strong optical fibers are difficult to cut through compared to the tubing, so the optical fibers that receive the damage act as a protective barrier for the other fibers in the bundle. The damaged fibers emit light through the jagged distortion aperture, and the undamaged fibers of the bundle continue to transmit light down the bundle. The flexible tubing may be solid or transparent. In an alternate embodiment, the tubing is partially blade cut at an angle to create the aperture, and then a blade is scraped against the exposed bundle of optical fibers to remove cladding. Other embodiments are additionally disclosed in the detailed description.

### BRIEF DESCRIPTION OF THE DRAWINGS

FIG. 1 is a perspective view of a section of tubing having distortion apertures and exposed optical fibers that have been damaged.

FIG. 2 is a cross sectional view through line 2-2 in FIG. 1.

FIG. 3 is a cross sectional view through line 3-3 in FIG. 1.

FIG. 4 is a perspective view showing numerous bundles extending from a light source.

FIG. 5 is a perspective view showing a section of tubing being abraded by a tool.

FIG. 6 is a perspective view showing a section of tubing being blade cut by a tool.

FIG. 7 is a perspective view showing a section of tubing being poked by a tool.

FIG. 8 is a perspective view showing a section of tubing being crushed by pounding a tool against the tubing.

FIG. 9 is a perspective view showing a section of tubing being crushed by rolling a tool over the tubing.

FIG. 10 is a perspective view showing a section of tubing being flattened by a tool.

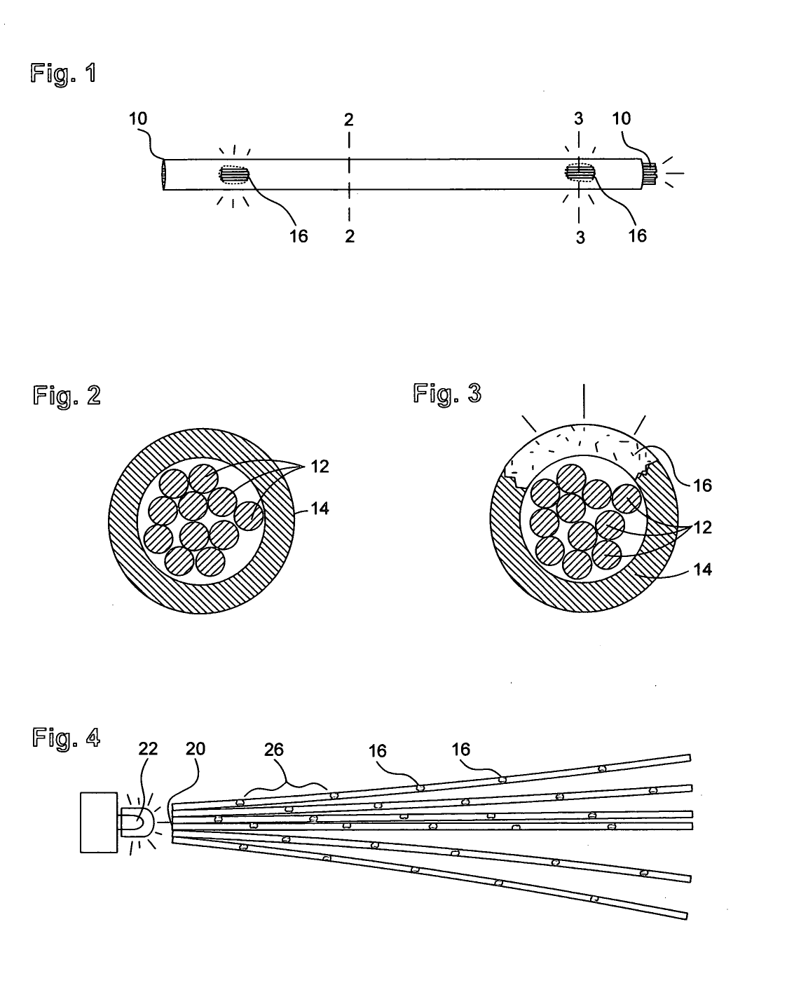

The following is the menu of numerical callouts used in FIGS. 1-10:

10 incoherent bundle

12 optical fibers

14 tubing

16 distortion aperture

18 tool

20 cut end

22 light source

24 segment

26 spacing

28 blade cut

30 flap

32 divot

34 scrapers

36 sharp point

38 blunt edge

40 pounded

42 rolled

44 Flattening

### DETAILED DESCRIPTION OF THE INVENTION

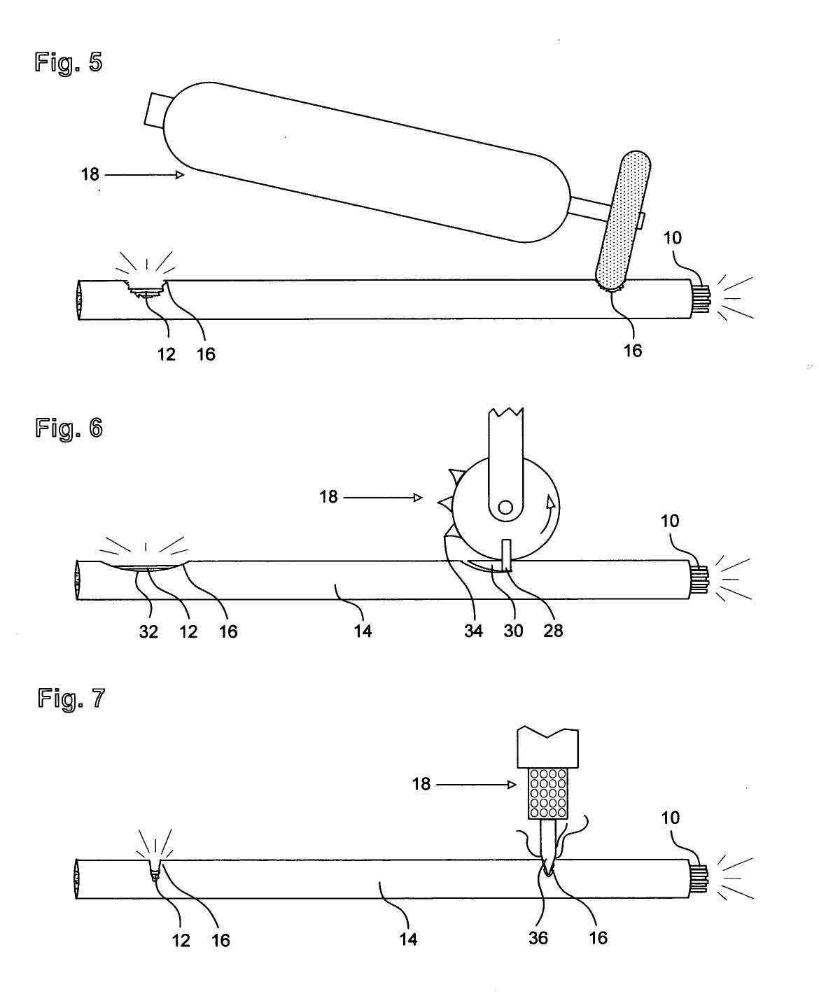

There are several methods described herein to achieve the desired results of the present invention, but all of the described methods have certain features in common, so similar callout numbers in the drawings carry similar meaning. As variously shown in FIGS. 5 through 10, the methods require that an incoherent bundle 10 of optical fibers 12 be surrounded by a tubing 14. With the optical fibers inside the tubing, the tubing is periodically partially cut, abraded, poked or otherwise worked so that damage to the optical fibers can be caused that creates numerous decorative lights that are spaced in relation to each other. In a first preferred embodiment, shown in FIGS. 5-7, a distortion aperture 16 is abraded, cut, poked or melted for the purpose of exposing the bundle to a tool 18 that can be applied through the aperture. The tool, which may be the same tool used to create the distortion aperture, is worked against at least one of the optical fibers in the bundle such that at least some cladding is damaged, resulting in a distortion of the light transmission of the bundle. In short, some or all of the internally reflected light in at least one waveguide is allowed to escape, depending on the extent of the damage. The distortion aperture may be used to direct light, especially where the tubing material is not transparent. The randomness of the damage means that some fibers may lose a considerable amount of their light through a distortion aperture, and other fibers may transmit substantially all of their light to a cut end 20 of the bundle to create the familiar spot of light seen on so many other optical fiber light displays. This randomness of light intensities allows for a less precise method because the light emanating from adjacent distortion apertures will never be identical, therefore no specific intensity is expected when viewing numerous tiny lights that form a soft lighting effect.

The optical fibers 12 used to make the decorative lights are preferably Plastic Optical Fiber, abbreviated POF, and more preferably PMMA (polymethyl methacrylate) because it is so readily available and inexpensive compared to other optical fibers. Other optical fibers will work, such as polyethylene therephthalate (PET), but the expense associated with better data transmission fiber is wasted on the method of the present invention. For a different lighting effect, side emitting optical fiber may be used, such as optical fiber that uses a clear Teflon material for the cladding, so that there is a continuous illumination effect that occasionally includes a brighter segment at a distortion aperture. End emitting optical fiber, such as PMMA core fiber that has a fluorinated polymer cladding layer, is well suited for most applications. Additionally, using smaller diameter optical fibers allows for a large number of optical fibers to be bundled inside of a relatively small and unimposing tubing, so numerous thin fibers is preferred over just a few large diameter optical fibers.

An incoherent bundle 10, shown in FIGS. 1-3, should have at least several optical fibers 12, but between a half dozen and a dozen is a good compromise. If there are more than about a dozen optical fibers, the cost per meter of a bundle increases more than the benefits usually justify. If there are five or fewer fibers, the light intensities are less controllable because there are so few fibers that can be severely damaged. In general, fewer fibers are needed if fewer light effects are needed. FIG. 4 shows how numerous bundles can be tightly grouped such that cut ends 20 from each optical fiber are close to a light source 22 that can illuminate all of the bundles. A second light source can be positioned at the opposite ends of the optical fibers to increase the light intensity of the bundle by having both ends of the fibers next to a light source. An LED or a LASER diode provides a good light source, and the light source may be color changing, as is shown in numerous other prior art devices.

FIGS. 1-3 show how the optical fibers 12 of the incoherent bundle 10 are held close to each other by a solid or transparent tubing 14. The bundle may be extruded within a plastic tubing, such as a PVC jacket. The bundle may be tightly held or loosely held by the tubing, and the preference for which should be used depends on the method used to damage the optical fibers. In general, loosely held optical fibers are more likely to slide out of position if they are severed, so it is better to tightly hold optical fibers when there is a large distortion aperture 16 through which fibers could fall out. It is not a significant concern if one of the various methods for creating the decorative light causes some of the fibers of the bundle to be fractured to the point of terminating the transmission of light through just those fibers. For a method that does not substantially harm the strength of an optical fiber, loosely held fibers are usually preferred because they tend to be easier to position and result in a more flexible bundle.

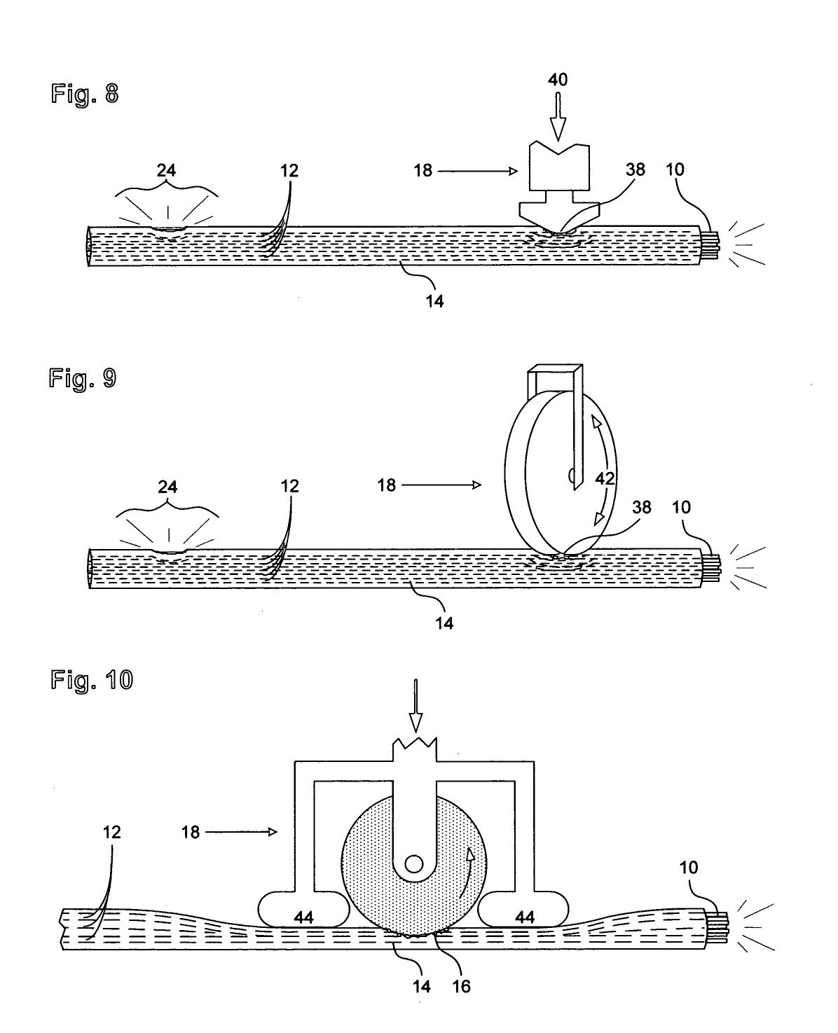

As depicted in FIGS. 8-10, transparent tubing 14, such as a clear polyurethane tubing, can provide a segment 24 of light where there is damage to the optical fibers 12. Mega-Glow™ cable, such as part number ALS-MG-7 available from Advanced Lighting Systems Inc. in Sauk Centre, Minn., is a ready-to-use combination of clear tubing and bundled optical fibers. FIGS. 1-7 depict an opaque tubing that will only allow light to be emitted through distortion apertures 16 provided in the tubing. A green or brown tubing would be well suited for use with a Christmas tree. Black, white or silver tubing would be appropriate for many common window frames. The size of the tubing is largely determined by the application, but 10 or 11 half millimeter optical fibers would easily fit inside of three millimeter outer diameter tubing having about a two millimeter inner diameter.

As shown in FIGS. 1-3, the most preferred method of the present invention creates a distortion aperture 16 and some optical fiber damage about every 100 to 200 millimeters to tubing and optical fibers 12 similar to what has been described above. The spacing 26 of an abrading process is not limited to this preference, but convention and aesthetics seem to prefer this spacing. If three millimeter tubing that carries about ten optical fibers is used, then a mechanically driven abrading tool 18, such as the rotary sanding wheel depicted in FIG. 5, can be pressed against the tubing until the tool cuts into the tubing and the cladding of at least a couple of optical fibers. A one millimeter deep distortion aperture should be about right, but this process does not need to be exact to produce good results. Consistency is not necessary, but avoiding damage to optical fiber cores is encouraged. It is recognized that the heat generated by friction will do some of the damage to the cladding of optical fibers, but the numerous and unpredictable nicks and cuts will open up the distortion aperture as well as damage at least some of the cladding. Once a distortion aperture and some optical fiber damage is caused, the tubing can be moved so that another distortion aperture with optical fiber damage can be created. Positioning the tubing on a hard surface is recommended. Also, it is generally easier to work the abrading tool perpendicular to the tubing, unless the tubing is secured or in a channel. Some applications may benefit from leaving a long section of tubing between the cut ends 20, shown in FIG. 4, nearest the light source 22 and the first distortion aperture so that the first decorative light is far away from the light source.

As shown in FIG. 6, an alternative way to create the distortion aperture 16 is to blade cut 28 the tubing 14 at a sharp angle to create a flap 30 or a divot 32 that exposes optical fibers 12. Initially, a blade can start to cut the tubing at a steeper angle, and then the angle of the blade can be brought parallel with the tubing after the interior of the tubing has been breeched, being careful to not cut through any optical fibers. This method should be obvious to anyone who has ever filleted a fish. A flap results if the blade is removed by lifting or pulling back the blade before cutting out a chunk of the tubing. A divot results if the blade is pulled away from the tubing while still cutting the tubing, or otherwise removing a flap of tubing. Once the tubing is cut, the exposed optical fibers can be abraded or otherwise damaged, such as by a scraping process that uses one or more scrapers 34 to work the exposed optical fibers, until the tool 18 sufficiently roughens the cladding. Alternatively, the blade could be positioned such that some cladding can be scraped away from several or even all of the optical fibers in the incoherent bundle 10.

FIG. 7 shows yet another alternative way to create a distortion aperture 16, which is by poking a tool 18 into the tubing 14. The tool may have a sharp point 36 and/or be hot enough to melt some of the tubing material. If the tool is hot enough, the cladding of optical fibers 12 that are touched by the tool will be damaged by heat. If the tool is not hot, another tool can be worked through the created distortion aperture to cause damage to the fibers. A single tool can accomplish both of these tasks if the tool has a sharp point that broadens into an abrading file. Such a tool can be poked all the way through a diameter of the tubing, or such a tool could be worked parallel to the optical fibers. Transparent tubing is required for this poking method because most flexible tubing will substantially close the distortion aperture once the tool is removed.

As shown in FIGS. 8 and 9, an alternate preferred method of the present invention is suitable for when it is undesirable to create a distortion aperture, but damage to the optical fibers 12 that are inside of the tubing 14 will still result. Damaging the fibers by this alternate method tends to be less predictable and it does damage the tubing. The method involves crushing the optical fibers in a bundle 10 against themselves until there is at least some damage to cladding. The crushing process can be performed by repeatedly tapping or compressing a segment 24 of tubing with a blunt edge 38 until numerous small fractures and breaks in at least some of the optical fibers are created. The damaged fibers will allow some light to escape. The blunt edge can be either pounded 40 against the tubing, as shown in FIG. 8, or rolled 42 back and forth over a cross section of the tubing, as shown in FIG. 9, until the optical fibers are forced to abrade each other, resulting in some of the cladding being damaged. The tubing should be at least somewhat transparent because the crushing method will not typically open up the tubing to provide an escape for side emitted light.

Any of the above methods for damaging bundled optical fibers may benefit from manipulating the tubing 14 and bundle 10 before introducing an abrasion, crushing or heating method. FIG. 10 shows how flattening 44 of the tubing and bundle can be used to control the depth of abrasion. If a roller is used to flatten the tubing, the optical fibers of the bundle will substantially lie in a plane. Knowing the position of substantially all of the optical fibers relative to a known plane can be tremendously beneficial for determining how to position and work a tool 18 used to damage optical fibers. For an automated process, including a flattening step will create more consistent results.

While a preferred form of the invention has been shown and described, it will be realized that alterations and modifications may be made thereto without departing from the scope of the following claims. For example, an application of the present invention is as an arrangement designed for use as a removable lighting system for a tree. Numerous optical fiber bundles prepared according to one of the methods shown and described in the present invention may be placed in a flexible casing with a reclosable opening, such as the one shown and described by Delmar in U.S. Pat. No. 6,779,906, incorporated herein by reference but not limitation.

What is claimed is:

1. A method of making a decorative optical fiber light display comprising the steps of:
surrounding an incoherent bundle of optical fibers with a tubing;
creating at least one distortion aperture in the tubing;
damaging at least one optical fiber of the incoherent bundle; and
illuminating the incoherent bundle with a light source such that a light transmission through the incoherent bundle is distorted where the at least one optical fiber was damaged, resulting in a decorative lighting effect.

2. The method of claim 1 wherein the step of creating the distortion aperture is characterized by an abrading process.

3. The method of claim 2 wherein the abrading process is characterized by pressing a mechanically driven abrading tool against a section of the tubing at least until the interior of the tubing is breeched, and wherein the step of damaging at least one optical fiber is characterized by pressing the mechanically driven abrading tool against the at least one optical fiber.

4. The method of claim 1 wherein the tubing is at least partially transparent such the decorative lighting effect at least partially emanates through a segment of the tubing and the distortion aperture.

5. The method of claim 1 wherein the tubing is substantially opaque, and wherein the decorative lighting effect at least partially emanates through the at least one distortion aperture.

6. The method of claim 1 wherein the step of creating the at least one distortion aperture is characterized by a cutting process that leaves a flap of tubing material attached to the tubing.

7. The method of claim 1 wherein the step of creating the at least one distortion aperture is characterized by a cutting process that cuts a divot in the tubing.

8. The method of claim 1 wherein in the step of damaging the at least one optical fiber is characterized by a scraping process that roughens a cladding material.

9. The method of claim 1 wherein the step of creating the distortion aperture is characterized by a melting process that melts at least a portion of the tubing.

10. The method of claim 1 wherein the step of damaging the at least one optical fiber is characterized by a melting process that damages optical properties of a cladding material.

11. A method of making a decorative optical fiber light display comprising the steps of:
surrounding an incoherent bundle of optical fibers with a tubing;
crushing at least one section of the tubing enough to damage at least one optical fiber of the incoherent bundle; and
illuminating the incoherent bundle with a light source such that the light transmission through the incoherent bundle is distorted at or near the at least one damaged optical fiber, resulting in a decorative lighting effect.

12. The method of claim 11 wherein the step of crushing is characterized by pounding at least one section of the tubing with a blunt object.

13. The method of claim 11 wherein the step of crushing is characterized by rolling a rigid object over at least one section of the tubing.

14. A decorative optical fiber light display comprising:
at least one incoherent bundle of optical fibers that is substantially contained inside of a length of tubing, each optical fiber of the at least one incoherent bundle being characterized by a core and a cladding;
at least one distortion aperture in the tubing;
damage to the cladding of at least one of the optical fibers;
a light source at a first end of the at least one incoherent bundle; and
wherein a light transmission through the at least one incoherent bundle at least partially escapes where there is damage to cladding, resulting in a decorative lighting effect.

15. The decorative optical fiber light display of claim 14 wherein the damage to the cladding is characterized by numerous abrasions.

16. The decorative optical fiber light display of claim 14 wherein the damage to the cladding is characterized by heat distortion of the cladding material.

17. The decorative optical fiber light display of claim 14 further comprising a second distortion aperture and a third distortion aperture, and wherein a distance from the at least one distortion aperture to the second distortion aperture is substantially the same as the distance from the second distortion aperture to the third distortion aperture.

18. The decorative optical fiber light display of claim 14 wherein the at least one distortion aperture is characterized by abrasion damage.

19. The decorative optical fiber light display of claim 14 wherein the at least one distortion aperture is characterized by a blade cut.

20. The decorative optical fiber light display of claim 14 further comprising a second light source positioned at a second end of the at least one incoherent bundle.
